(19) United States
(12) Patent Application Publication
(10) Pub. No.: US 2011/0100529 A1
(43) Pub. Date: May 5, 2011

(54) Means and a method for connecting pieces of a tube

(76) Inventors: Orson Bourne, Ottawa (CA); Charles Strong, Ottawa (CA)

(21) Appl. No.: 11/798,860

(22) Filed: May 17, 2007

Related U.S. Application Data
(60) Provisional application No. 60/800,841, filed on May 17, 2006.

(51) Int. Cl. B29C 73/06; B29C 73/08; B32B 1/08; B82Y 30/00

(52) U.S. Cl. 156/94; 156/423; 428/34.1; 428/36.9; 977/902; 977/742; 977/750

(57) ABSTRACT

Connecting means for connecting a first piece of hollow tube to a second piece of hollow tube. This means comprises an insert, where the insert is a hollow shaft having an external and an internal cross section. The internal cross section of said insert having a central rectangular section. The internal cross section having a first and a second tapered sections on either side of the central rectangular section tapering down from the height of the central rectangular section down to zero. The external cross section of the insert is adapted to fit snuggly inside the first piece of hollow tube and said second piece of hollow tube and the insert is adapted to minimize the peak stress transfer loading between the insert and the first and second piece of hollow tube. It also comprises a bonding means, where the bonding means adapted to secure the insert to the inside said first and second piece of hollow tube. The invention also consists in a kit. A kit which would comprise of an insert, the insert being a hollow tube adapted to fit snuggly inside a first piece of hollow shaft and a second piece of hollow shaft, a bonding means, and instruction on how to install said insert to connect the first and the second hollow shafts.

This application claims the benefit of U.S. Provisional Application 60/800,841 filed May 17, 2006.

### FIELD OF THE INVENTION

This invention relates to a means and a method of connecting two pieces of a hollow tube. More specifically to a composite insert adapted to connected two pieces of hollow tube such as a hollow hockey stick shaft.

### BACKGROUND OF THE INVENTION

Over the years, advancements in material technology have lead to increase sophistication in the manufacturing and performance of hockey sticks.

In the past hockey sticks were manufactured primarily of wood. The wood stick comprised a solid shaft either machined out of a single piece of wood or by sandwiching multiple layers of wood together. These solid shafts were heavy and had very little flexibility. The ability to induce flex into a stick is desirable. The energy stored in the flex generates a greater release of velocity to the puck during a slap shot or faster release during a wrist or snap shot than a stick that has no flex.

Through the use of advanced material technologies, modern hockey sticks are now manufactured from a wide variety of materials. In addition to the wood, and materials such as aluminum, high performance polymers and composite materials are being used. Such composites materials comprise, but are not limited to, fiber glass Kevlar and/or carbon fiber.

One way in which these materials have changed stick construction is the development of hockey sticks with hollow shafts that are relatively easy to flex in comparison to a solid wooden shaft. This is only made possible because of the superior mechanical properties that these new materials have over wood. Since a hollow shaft is inherently lighter than a solid shaft made from the same material, hockey sticks made from these materials are normally lighter than their wooden counterparts.

Composite hollow shaft manufactures can tune the stiffness of the shaft by varying the amount or type of resin and/or fiber that is used. In general the flex of a composite hollow shaft is controlled by the cross sectional area of the shaft, the thinner the layer the easier it is to flex for a given fiber resin combination. Alternatively the cross section dimensions can be kept constant and the resin fiber combination adjusted. Cost, manufacturability and mechanical strength are the deciding factors for choice of method.

Using these new materials, stick suppliers have been able to tune the hockey stick performance characteristics particularly in the areas of weight and stick flex and flex point. However these properties are fixed at the point of manufacture.

Representative designs of such hollow shafts comprise U.S. Pat. No. 4,086,115 issued to Sweet Jr et al. which discloses a stick having a glass fiber shaft with an interchangeable blade made of polycarbonate; U.S. Pat. No. 5,303,916 to Rodgers discloses such an improved hockey stick shaft formed by pultrasion of a plurality of discrete layer of random strand mat glass fiber; U.S. Pat. No. 5,636,836 to Caroll et al discloses a hollow composite shaft where either end of the shaft can be used to insert the blade; U.S. Pat. No. 5,746,955 to Calapp et al. discloses a means of making a composite hockey shaft adapted to receive a replaceable blade; U.S. Pat. No. 6,117,029 to Lunisaki et al. discloses a method of making a hockey stick shaft that includes a metallic tip; U.S. Pat. No. 6,241,633 to Conroy; again discusses a hockey shaft adapted to receive a blade, the shaft having a plurality of layers, and finally U.S. Pat. No. 6,267,697 to Sulenta discusses a triangular shaft;

With the design of the hollow shaft came the requirement of securing a blade to the shaft. A few examples are listed below.

U.S. Pat. No. 3,934,875 issued to Easton which describe a fiber-reinforced plastic blade integrally molded onto a metal shank which mates with an aluminum alloy shaft; U.S. Pat. No. 5,419,553 to Rodgers; U.S. Pat. No. 5,447,306 to Selden discusses a means of connecting a blade to a hollow shaft which comprises an intermediate shank; U.S. Pat. No. 5,496,027 to Christian et al discloses a braided tubular sleeve used in order to connect a blade to a shaft. This sleeve would elongate this portion of the stick and would change it's characteristics; U.S. Pat. Nos. 5,628,509 and 5,695,416 to Christian discusses a means of connecting a hollow hockey shaft to a blade which is adhesive free; U.S. Pat. No. 6,224,505 to Burger discloses the use of a cloth fabric being wrapped around the shaft to permit removal and/or insertion of the blade without damaging the shaft;

All of these patents, and patent applications are hereby incorporated herein by reference to the extent not inconsistent with the present disclosure.

With the development of these technologically advanced hockey sticks, suppliers have been able to charge a premium when selling these high performance hockey sticks to the public.

The major limitation of all of these designs is that all of these composite sticks are prone to breakage during normal use. This breakage is believed to originate from micro cracks which are either stress induced and/or caused by a previous impact. As the new shaft and stick designs often have a significant replacement cost associated with them, this can lead to significant warranty and service issues for suppliers as well as frustration on the part of consumers.

From the onset consumers have been seeking ways to repair the performance of this new generation of shafts. The first of these used modified wooden shaft extenders. There have been used for a number of years to extend the length of a hollow hockey shaft and an example of such a device is shown in FIG. 1 a (prior art). One end of the device has the internal cross sectional dimensions of the shaft and the other end it's external cross sectional dimensions. Consumers quickly recognize that if both ends are given the internal cross sectional dimensions of the shaft they could be used to repair a broken hollow shaft. An example of such a repair attempt is shown in FIG. 1b. Part A has been shaped to fit into the two parts of broken shaft B. This type of repair insert has however proven to be impractical and the repaired shaft's performance was unsatisfactory. The major reasons were weight, poor flexibility, low strength and it could not reproduce the all important “feel” (strength: weight: flexibility ratio) that was present in the original shaft.

Attempts to improve on this repair method were made by replacing the wooden insert with a composite insert with a substantially similar cross section to the original shaft. An example is shown in FIG. 2. In normal use a shaft is subjected to severe stress cycling. The magnitude of this stress can approach 100 kpa. There is a finite distance over which this stress is transferred from one part of the shaft B to the insert A and back to the shaft B. The shorter the distance over which this transfer takes place the higher the peak stress value the interface must endure as show in pictorial in FIG. 2. Failure at the joint interface caused by stress severely limited the viability of this repair option.

Other attempts to solve the strength repair issue include the technology marketed by SRS™ system (www.srshockey.com). In this system a composite plug is inserted between the two parts of the broken shaft. Expanding glue and notches cut within the shaft are then used to hold the patch in place. This solution is technically challenging and can only be performed by a skilled operator. It takes up to 96 hours to complete and more importantly the feel (stench: weight; flexibility ratio) of the original shaft cannot be reproduced.

An alternative method marketed by Stick fix uses a hand lay up composite patch to splice the two parts of a broken shaft together. As is the case with the SRS™ system method, it requires a skilled operator and takes at least 48 hours to complete.

### SUMMARY OF THE INVENTION

An object of this invention is to propose a shaft repair means and kit that will mimic the performance and feel of the original shaft.

Another object of this invention is to propose a shaft repair means and kit that will be a “do it yourself” means.

Another object of this invention is to propose a shaft repair means and kit that will provide the option to either maintain the original kick point of the shaft or be adjustable to players needs.

One embodiment of the invention is a connecting means for connecting a first piece of hollow tube to a second piece of hollow tube. This means comprises an insert, where the insert is a hollow shaft having an external and an internal cross section. The internal cross section of said insert having a central rectangular section. The internal cross section having a first and a second tapered sections on either side of the central rectangular section tapering down from the height of the central rectangular section down to zero. The external cross section of the insert is adapted to fit snuggly inside the first piece of hollow tube and said second piece of hollow tube and the insert is adapted to minimize the peak stress transfer loading between the insert and the first and second piece of hollow tube. It also comprises a bonding means, where the bonding means adapted to secure the insert to the inside said first and second piece of hollow tube.

The invention also consists in a kit. A kit which would comprise of an insert, the insert being a hollow tube adapted to fit snuggly inside a first piece of hollow shaft and a second piece of hollow shaft, a bonding means, and instruction on how to install said insert to connect the first and the second hollow shafts.

### BRIEF DESCRIPTION OF THE DRAWINGS

FIG. 1 (prior art) illustrates a wooden shaft extender.

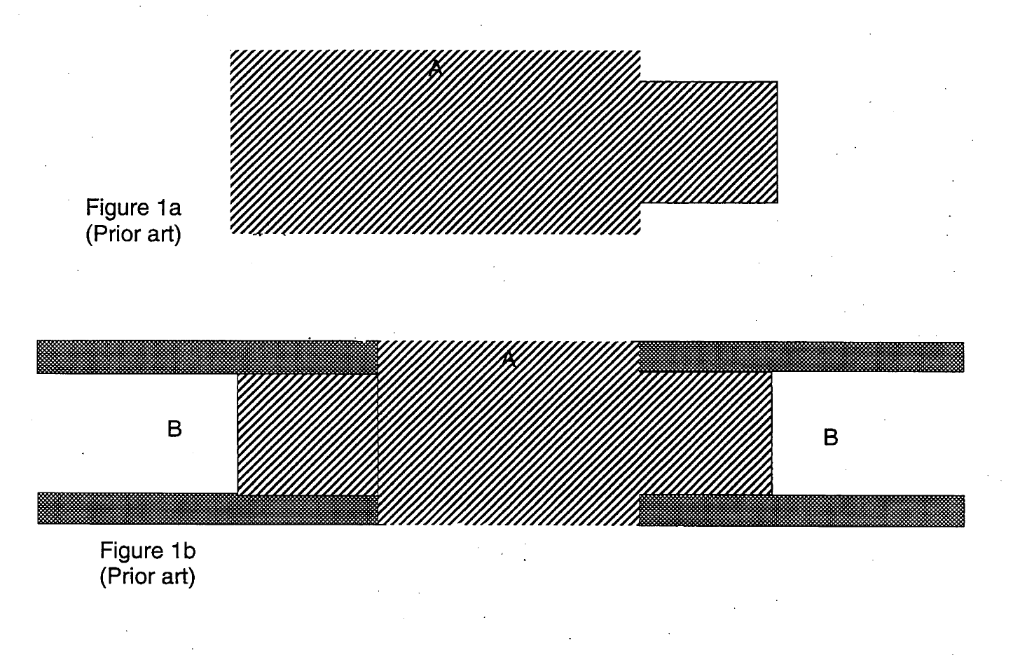

FIG. 2 (prior art) illustrates a composite insert of similar cross section as the tube.

FIG. 3 illustrates one embodiment of the invention.

FIG. 4 illustrates a second embodiment of the invention.

FIG. 5 illustrates a cross section of one embodiment of the invention used in a rectangular cross section shaft.

### DESCRIPTION OF PREFERRED EMBODIMENTS

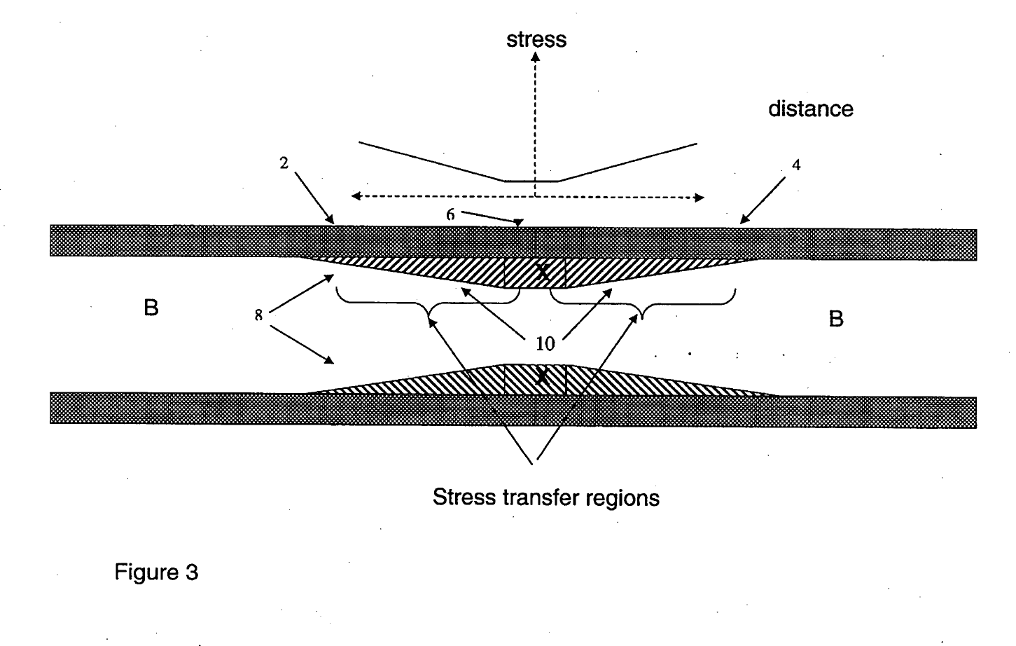

FIG. 3 illustrates an insert that minimizes the peak stress transfer loading between the insert (8) and a first and a second part of a shaft (2 and 4) that it links. The insert (8) can be made of composite materials.

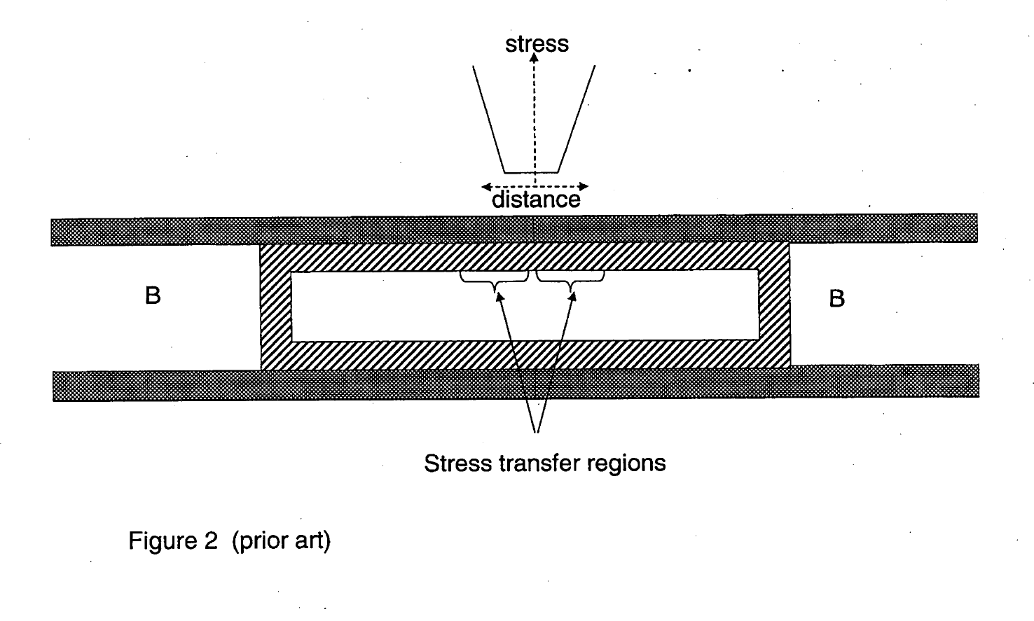

In a composite joint, inappropriate stress transfer at the joint interfaces is the major mechanism for joint failure. The shorter the distance over which the transfer takes place the greater the peak stresses at the interfaces. This is shown schematically in FIG. 2 (prior art).

FIG. 3 illustrates an embodiment of the invention where the distance over which the stress is transferred between the two regions is maximized. FIG. 3 illustrates a first tube or shaft (2) and a second tube or shaft (4) that we wish to connect to the first tube (2). The connecting point (6) is where it is desired to reduce the stress. The insert (8) has been designed to maximize the distance over which the stress is transferred between the two shafts (2) and (4). The internal cross section geometry of the insert (8) has a central rectangular section (X), a first and a second tapered sections (10) situated on either side of the central rectangular section (X). The tapered sections (10) increase the stress transfer distance and ensures a gradual, instead of a discontinuous transfer of stress from the insert to the two parts of the tube or shaft (2) and (4) that need to be connected.

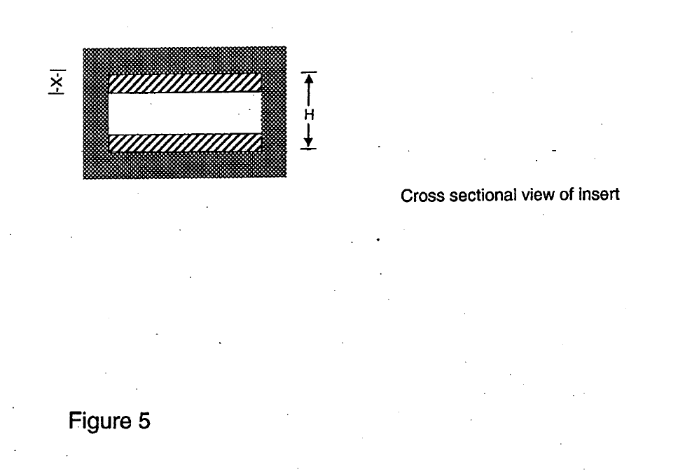

The dimensions of the insert (8) will depend on the material chosen. But typically the total length will range around 15 to 30 cm long. It can sometimes be less than 25 cm. The length of the central rectangular section (X) can range between 3 to 10 cm long. The central rectangular section (X) can range between 7 and 10 cm long, again its length will depend on the type of material being used. The length of each tapered section (10) can range from 6 to 10 cm. The length of the first and the second tapered section can range from 7 to 10 cm, again the length would depend on the material being used. The maximum height of the central rectangular section (X) should be no more that 25% of the total cavity height (H), therefore leaving approximately 50% of the cavity height unoccupied (U) as illustrated in FIG. 5.

The external cross section of the insert (8) is adapted to fit snuggly inside the first and the second piece of the hollow tube (2) and (4) and therefore matching the shape of the internal cavity of the original shaft. It can be of various shapes. Although, for most hockey sticks, this would be a rectangular cross section, as illustrated in FIG. 5, other shapes such as oval, circular, triangular, hexagonal, or any other shape that would match the interior cavity of the shafts needing to be connected can be used.

A composite material that comprises a carbon fiber and either an epoxy resin or epoxy system that incorporates nanoparticles, in particular single wall carbon nanotubes (SWNT) to increase the mechanical properties (in particular the toughness) of either the resin or resin system can be used to make the insert. Although in an example of the invention the composite is a carbon fiber epoxy structure other material combinations can be used. For example Kevlar, glass fiber or UHDPE etc could be used as the fiber material. The fibers could also be natural or man made. The resins could either be a thermoset (epoxy, vinyl esters) or a thermoplastic (nylon, polycarbonate).

The major failure mechanism in a composite hockey shaft normally originates from a micro fracture. More likely than not, this fracture originated in the epoxy resin that binds the individual fiber layers together. Nanoparticles in particular single wall carbon nanotubes (SWNT) are known to improve the fracture toughness. As little as 0.1% loading of SWNT can increase the fracture toughness of an epoxy resin by as much as 45% and its tensile strength by 65%. The net effect is a tougher composite structure.

A binding agent such as glue is used to bind the insert to the two parts of the broken shaft. The requirements are good adhesion to all surfaces and good resistance to fracture toughness. Nanoparticles and in particular SWNT can improve the performance of an epoxy resin used as a binding agent.

A binding agent that has been reinforced with SWNT to bind the inserts to the two parts of the broken shaft can be used. This binding agent could be any adhesive system, organic or inorganic that is capable of forming a bond. For example wax could be the binding agent. However it is preferred the binding agent be reinforced with nanotubes for added performance.

By selecting the appropriate combination of fiber and resin, feel, strength, appearance and flex of the original stick can be reproduced or adjusted. Different mechanical properties can be achieved by using different Individual fiber types, using them individually or weaving them, layering different materials together or using different types of resin to bind the layers together. All of these variables can be used to alter the look, feel and strength of the stick.

Because the insert (8) is constructed using the same technology that was used to create the original shaft it can be provided in a range of flexes. The player can now choose the insert that best fits his needs. Moreover given that the insert fits internally (see FIG. 3) the appearance of the original stick is maintained.

The player can tune the “feel” of a standard but unbroken shaft to his or her preferred liking, in particular the location of the kick point and its performance can be self customized.

The insert could be sold as a kit along with the adhesive means and with the instructions on how to repair a broken stick. The instructions would follow the method to repair the stick provided below.

The method would first comprise in squaring the edges of the broken shaft. This could easily be done with a saw or any other similar tool. Once the first (2) and the second (4) pieces of the shaft have been squared off, the edges and the interior of the broken shaft would have to be cleaned of any loose materials. Then applying an adhesive means such as a binding agent to the exterior of the insert (8) and to interior of the broken end of first (2) and the second (4) pieces of the shaft. Once the binding agent has been applied, the insert can be inserted inside the first (2) an the second (4) piece of the shaft. Allowing the binging agent to cure.

In the instance where the length of the shaft was not affected by the break, the first and the second piece of the shaft would be brought together to connect before curing. If there is a desire to have a gap in order to maintain the length of the shaft, a cover can be used to cover the exposed insert.

The focus of the invention so far has been on its ability to repair a broken hollow shaft. However given that the cross sectional dimensions of a composite shaft are constant over 90% of its length and a range of inserts with different flexes can be produced, the player for the first time can self customize the location and performance .of the kick point of a standard hollow shaft.

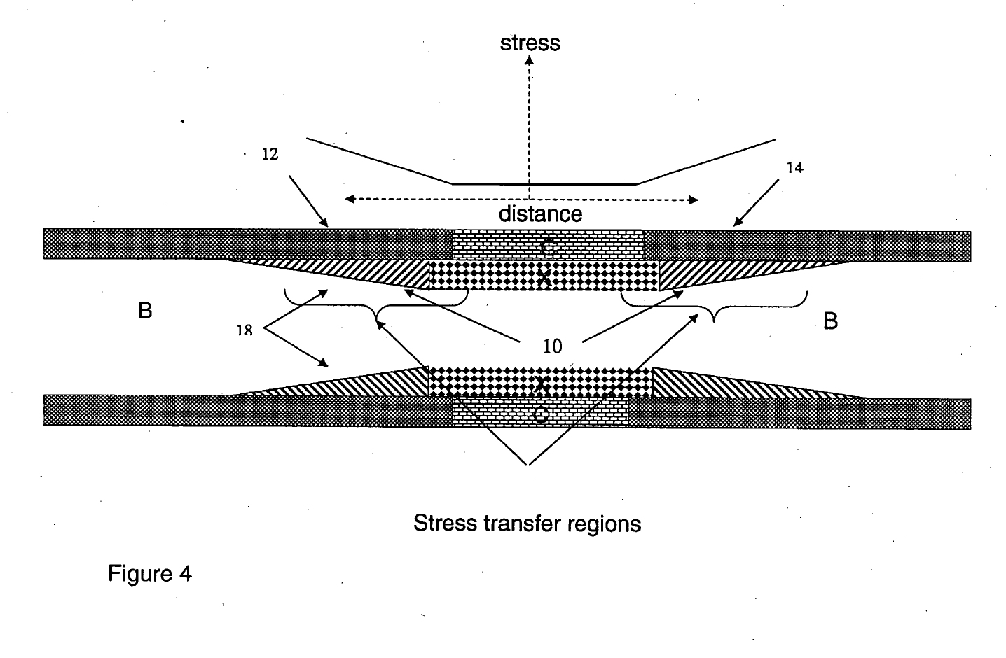

This is accomplished as follows. A variant of the insert shown in FIG. 3 is shown in FIG. 4. In the FIG. 3 the central rectangular region of the insert that eventually carries the full load (label X in FIG. 3) is kept to the shortest practical length, typically approximately 3 cm out of the total length of approximately 15 cm. However this region can be extended to any length (typically between 7 cm to 10 cm) as shown in FIG. 4. In this variant the total length of the insert can be as long as needed but is typically <25 cm. The “feel” of this region (X′) need not be the same as the rest of the insert or the original shaft, as shown pictorially in FIG. 4. This feel can be adjusted by a combination of fiber type, resin type and geometry. By situating this particular style of insert at the location of choice in the shaft the “kick” point of a shaft can be customized by the player.

The player achieves this by cutting the original shaft at the desired location and using the insert to rejoin a first (12) and a second (14) piece as shown in FIG. 4. Note only the regions needed for bonding typically 5-10 cm is covered by the original shaft, the remainder of the insert (18) is exposed. To generate the appearance of an unmodified stick a cosmetic cover (C in FIG. 4) is used to cover this exposed region. This cover has the same external dimensions of the original shaft therefore cross section of the original shaft is reproduced. The cover could be any material that would reproduce the original look of the shaft (although it would not have to be) and would typically be any thermoplastic of the desired shape.

A number of prototypes of both types of inserts have been built from carbon fiber strand bonded together by a SWNT/Westway resin formulation using the hand layup method. This initial set of inserts increased the overall weight of the stick by <10%. We know of no technical reason why this value cannot be reduced to <5% by optimizing the resin fiber SWNT composite formulation. In tests performed by elite players no difference in feel was reported in on ice trials for the standard repair insert (FIG. 3) and the kick point of a given shaft could be adjusted by using the variant shown in FIG. 4.

The method for inserting a insert to modify the flex point of a stick would consist in first cutting the stick at a desired location. Cleaning of any loose materials the edges and the interior of the broken shaft. Then applying a binding agent to the exterior of the insert (8) and to interior of the first end (2) and the second end (4) pieces of the shaft. Once the binding agent has been applied, the insert can be inserted inside the first (2) an the second (4) piece of the shaft at the desired depth. Allowing the binging agent to cure. Covering the exposed insert with a cover.

1. A connecting means for connecting a first piece of hollow tube to a second piece of hollow tube comprising;
An insert,
Said insert being a hollow shaft having an external and an internal cross section,
Said internal cross section of said insert having a central rectangular section,
Said internal cross section having a first and a second tapered sections on either side of said central rectangular section tapering down from the height of the central rectangular section to zero,
Said external cross section is adapted to fit snuggly inside said first piece of hollow tube and said second piece of hollow tube,
Said insert adapted to minimize the peak stress transfer loading between the insert and the first and second piece of hollow tube,
an adhesive means,
Said adhesive means adapted to secure the insert to the first and second piece of hollow tube.

2. The connecting means of claim 1 where said insert is made of a composite material.

3. The connecting means of claim 2 where said insert is made of a thermoset or a thermoplastic material.

4. The connecting means of claim 2 where the composite material contains a nanotube.

5. The connecting means of claim 2 where the composite material contains a single wall nanotube.

6. The connecting means of claim 1 where the insert has a total length between 15 and 30 cm long.

7. The connecting means of claim 6 where the insert has a total length of less than 25 cm.

8. The connecting means of claim 6 where the central rectangular part has a total length between 3 and 10 cm long.

9. The connecting means of claim 8 where the central rectangular part has a length between 7 and 10 cm long.

10. The connecting means of claim 6 where the first and the second tapered sections each have a length between 6 and 10 cm long.

11. The connecting means of claim where the first and the second tapered sections each have a length between 7 and 10 cm long.

12. The connecting means of claim 1 where the central rectangular section has a height of less than 25% of the height of the cavity.

13. The connecting means of claim 1 where said adhesive means is a binding agent reinforced with carbon nanotube.

14. The connecting means of claim 1 where said adhesive means is a binding agent reinforced with single wall carbon nanotube.

15. The connecting means of claim 1 where said insert is used to locate the “kick’ point of a hockey stick in a user defined location.

16. A hockey shaft repair kit,
A kit comprising;
a insert,
said insert being an hollow tube adapted to fit snuggly inside a first piece of hollow shaft and a second piece of hollow shaft,
an adhesive means,
and instruction on how to install said insert.

17. The kit of claim 16 where said insert is made of a composite material.

18. The kit of claim 17 where said composite material contains a nanotube.

19. The kit of claim 17 where said composite material contains a single wall nanotube.

20. The kit of claim 16 where said insert has a central cross section which tapers from a central rectangular cross section to zero on either side of said central rectangular cross section.

21. The kit of claim 16 where said insert is made of a specific fiber and resin in order to provide specific flex and strength to the shaft.

22. The kit of claim 16 where said kit is used to locate the “kick’ point of a hockey stick in a user defined location.

23. The kit of clam 16 further comprising a cover to place over the insert.

24. The kit of claim 16 where the kit indicated a flex rating.

25. A method for connecting a first and a second piece of a shaft comprising the following steps;
1) squaring the edges of the first and the second piece of the shaft;
2) cleaning the edges and the interior of the first and the second piece of the shaft of any loose materials;
3) applying an adhesive means to the exterior of an insert (8) having a central rectangular location and two tapered sections on either side of said central rectangular location and to interior of the first (2) and the second (4) pieces of the shaft;
4) inserting the insert inside the first (2) an the second (4) piece of the shaft;
5) allowing the adhesive means to cure.
